(19) United States
(12) Patent Application Publication
(10) Pub. No.: US 2023/0102205 A1
(43) Pub. Date: Mar. 30, 2023

(54) ROAD SIGN INFORMATION PRESENTATION

(71) Applicant: Lenovo (United States) Inc., Morrisville, NC (US)

(72) Inventors: Mark Delaney, Raleigh, NC (US); John C. Mese, Cary, NC (US); Arnold Weksler, Raleigh, NC (US); Russell Speight VanBlon, Raleigh, NC (US); Nathan Peterson, Oxford, NC (US); Anna Preseren, Raleigh, NC (US)

(21) Appl. No.: 17/490,883

(22) Filed: Sep. 30, 2021

(51) Int. Cl. G06F 16/28; G06K 9/00; G06F 16/22; G06F 16/9537; G01S 19/01; B60K 35/00; B60R 1/00

(52) U.S. Cl. CPC G06F 16/287; G06K 9/00818; G06F 16/22; G06F 16/9537; G01S 19/01; B60K 35/00; B60R 1/00; B60K 2370/166; B60K 2370/178

(57) ABSTRACT

One embodiment provides a method, including: receiving, at an information handling device connected to a vehicle, an indication of a road sign in proximity to the vehicle; storing, subsequent to the capturing, information associated with the road sign in a data repository; identifying, by accessing a ruleset, a point at which to provide the information associated with the road sign to a user; and providing, responsive to the identifying and by accessing the data repository, the information to the user at the identified point. Other aspects are described and claimed.

### BACKGROUND

Modern vehicles (e.g., cars, motorcycles, etc.) contain a variety of different types of sensors and/or displays that may aid a user that operates the vehicle. For instance, camera sensors integrated into the vehicle may be able to capture images of various signs the vehicle passes on the road. These images may be analyzed and the information associated with these road signs may thereafter be presented to the user on an information handling device (“device”) associated with the vehicle (e.g., on a display screen of a navigation system integrated into the vehicle, a user's personal device linked to the vehicle, etc.).

### BRIEF SUMMARY

In summary, one aspect provides a method, including: receiving, at an information handling device connected to a vehicle, an indication of a road sign in proximity to the vehicle; storing, subsequent to the capturing, information associated with the road sign in a data repository; identifying, by accessing a ruleset, a point at which to provide the information associated with the road sign to a user; and providing, responsive to the identifying and by accessing the data repository, the information to the user at the identified point.

Another aspect provides an information handling device, including: a processor; wherein the information handling device is connected to a vehicle; a memory device that stores instructions executable by the processor to: receive an indication of a road sign in proximity to vehicle; store, subsequent to the capturing, information associated with the road sign in a data repository; identify, by accessing a ruleset, a point at which to provide the information associated with the road sign to a user; and provide, responsive to the identifying and by accessing the data repository, the information to the user at the identified point.

A further aspect provides a product, including: a storage device that stores code, the code being executable by a processor and comprising: code that receives, at an information handling device connected to a vehicle, an indication of a road sign in proximity to the vehicle; code that stores, subsequent to the capturing, information associated with the road sign in a data repository; code that identifies, by accessing a ruleset, a point at which to provide the information associated with the road sign to a user; and code that provides, responsive to the code that identifies and by accessing the data repository, the information to the user at the identified point.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of providing road sign information to a user

FIG. 4 provides an example illustration of road sign information presentation according to an embodiment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Individuals encounter a variety of different types of road signs while operating a vehicle (e.g., a car, a motorcycle, etc.). Common road signs that a vehicle operator may encounter include: product or service advertisement signs (e.g., signs that indicate upcoming restaurants, gas stations, hotels, etc.), traffic control signs (e.g., that provide an indication of an upcoming change to a traffic pattern, etc.), emergency alert signs (e.g., that may alert a user of a certain social or environmental danger, etc.), and many others. As technology has progressed, many vehicles have become outfitted with various types of sensors that are capable of dynamically capturing signage information and thereafter presenting that information to a user (e.g., on a display of a navigation system integrated into a vehicle console, on a heads-up display (“HUD”), etc.).

Although conventional systems may capture and present roadside information to a user, they are not configured to present that information in a way that optimizes a user's ability to react and/or utilize that information in a meaningful way. For example, it is not uncommon for users to pass a road sign for products or services that they may be interested in only to soon forget the road exit that these products or services are located at. Accordingly, a system that simply identifies a sign for these products or services and immediately presents an indication of the sign to the user (e.g., as the sign is detected, etc.) may not help the user obtain these products or services as much as one that can provide a reminder of the sign information at a strategically relevant point.

Accordingly, an embodiment provides a method for presenting relevant road sign information to a user. In an embodiment, an indication of a road sign passed by a user's vehicle may be received at a device associated with the vehicle. An embodiment may then store information associated with the road sign in an accessible data store and thereafter identify a point at which to provide the information to the user (e.g., a distance past the road sign, a time after the road sign has been passed, a distance before an exit corresponding to the road sign, etc.). Responsive to identifying that the point has been reached, an embodiment may then automatically provide the information to the user. Such a method may remind users of relevant signs that they have recently passed so that a user may, if they choose, utilize the information presented on those signs.

The illustrated example embodiments will be best understood by reference to the figures. The following description is intended only by way of example, and simply illustrates certain example embodiments.

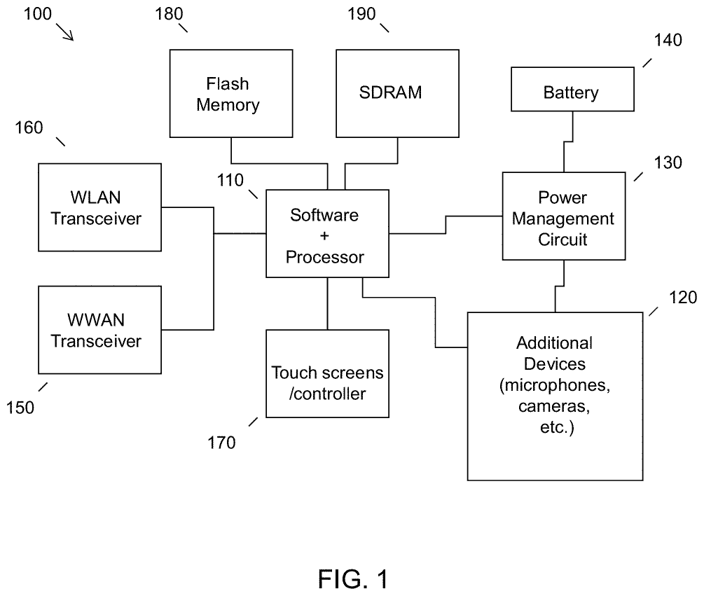

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

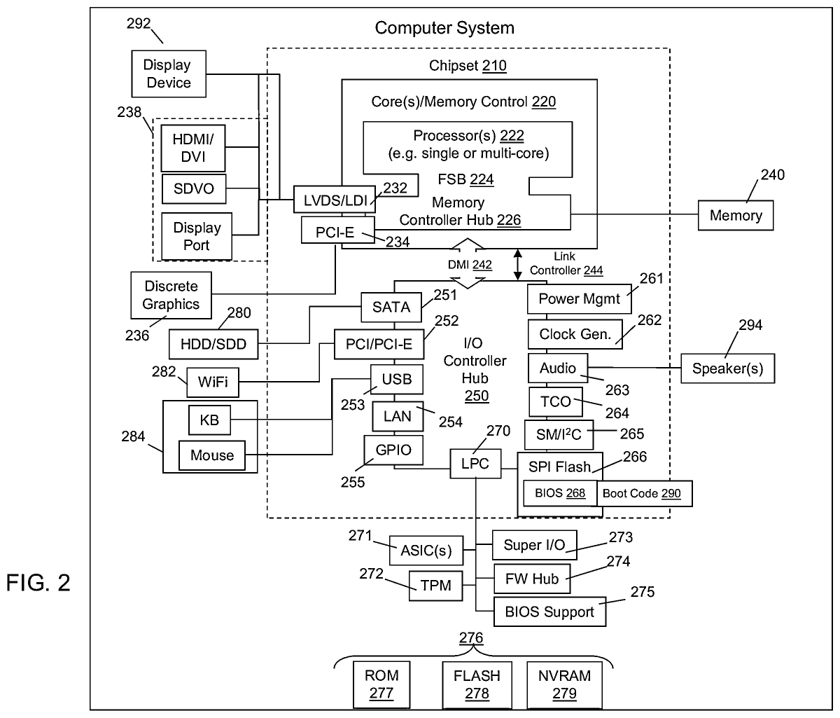

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling circuitry, as for example outlined in FIG. 1 or FIG. 2, may be used in computing devices that are integrated or operatively coupled to a vehicle and capable of receiving and/or processing road sign information data. For example, the circuitry outlined in FIG. 1 may be implemented in a smart phone operatively coupled to a vehicle, whereas the circuitry outlined in FIG. 2 may be implemented into a computer.

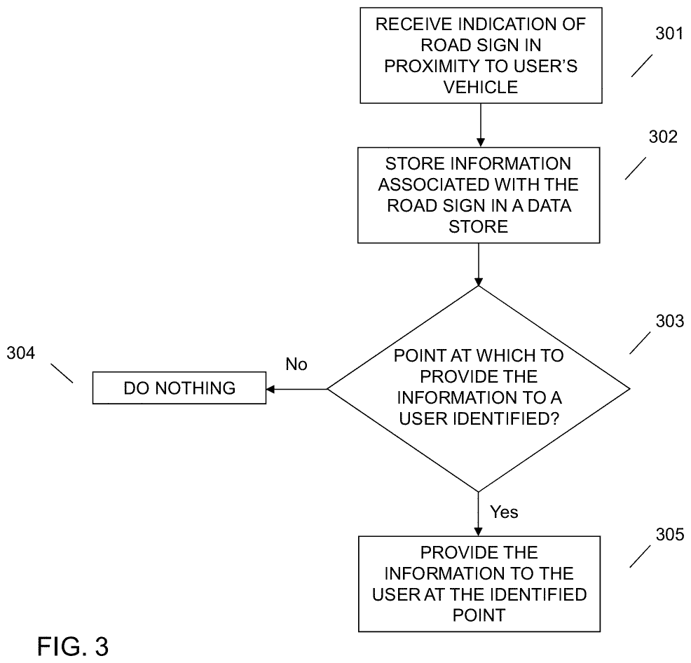

Referring now to FIG. 3, an embodiment provides a method of providing desired roadside information to a user at a strategically relevant point. At 301, an embodiment may receive an indication at a device of a road sign in proximity to a user. In an embodiment, the device that receives the indication may be any one of: a user's standalone personal device (e.g., a smart phone, a wearable device such as a smart watch, a tablet, etc.), a user's personal device that is physically or wirelessly connected to a vehicle (e.g., via a physical cable, BLUETOOTH, etc.), or a device that is integrated into the vehicle (e.g., a vehicle's central navigation system, etc.).

In an embodiment, the road sign may be a sign that is proximate to a user's person (i.e., for pedestrian users) or that is proximate to a vehicle that the user is operating. Regarding the latter, the vehicle may be virtually any type of vehicle (e.g., bicycle, car, bus, motorcycle, etc.) that may be operated on the road. In an embodiment, the road sign may be virtually any category of road sign that provides information to a user. Non-limiting examples of applicable road signs include: product or service advertisement signs (e.g., signs that indicate upcoming restaurants, gas stations, hotels, etc.), traffic control signs (e.g., signs that provide an indication of an upcoming change to a traffic pattern, etc.), emergency alert signs (e.g., signs that may alert a user of a certain social or environmental danger, etc.), billboard signs, and the like. In an embodiment, the road sign may be an upcoming road sign or a road sign that the user has just passed.

In an embodiment, the indication of the proximate road sign may be received in one or more different ways. In one instance, an embodiment may leverage sensor data obtained from sensors (e.g., camera sensors, etc.) on the device or sensor data obtained from sensors on a vehicle that are transmitted to the device. For example, one or more camera sensors integrated within a car may be able to capture (e.g., continuously, at predetermined intervals, etc.) images or videos of the road. An embodiment may analyze these images (e.g., using one or more conventional image or video analysis techniques known in the art, etc.) and compare them to a known road sign database to determine whether a road sign is present that the car is passing or is about to pass. In another instance, an embodiment may leverage knowledge of a user's or a vehicle's geographic position (e.g., from global positioning system (“GPS”) data, etc.) to identify whether they are proximate to a known road sign (where knowledge regarding the location of the road sign and/or information contained within the road sign is found within an accessible database (e.g., a programmed list, an online source, etc.)).

At 302, an embodiment may store information associated with the road sign in a data repository. In the context of this application, information associated with the road sign may include some or all of: text, images, or videos contained within the boundary of the sign. In an embodiment, the data repository may be a data store located locally on the device or may be a data store located on a remote or cloud-based server accessible by the device.

In an embodiment, a user may configure the system settings of the device to only store information associated with certain categories of signs. For instance, in an embodiment, a user may desire to store information for each and every sign passed by the user. Alternatively, in another embodiment, a user may adjust the system settings to only store information from the category of road signs that advertise upcoming service facilities (e.g., restaurants, gas stations, hotels, etc.) and disregard all other signage information not associated with the designated category.

At 303, an embodiment may identify a point at which to provide the information associated with the road sign to a user. In an embodiment, the identification may be facilitated by accessing a ruleset (e.g., stored locally on the device, stored remotely on another device or server, etc.) that identifies the criteria for what constitutes an information-providing point. In an embodiment, the ruleset may be originally instituted by a programmer of the device or a manufacturer of the vehicle and may be later adjusted by a user.

In an embodiment, the ruleset may specify that the point corresponds to a predetermined distance that a user or vehicle has traveled past a road sign. For example, the ruleset may specify that information associated with a road sign should be provided to the user 5 miles past the road sign. Responsive to identifying that the user is the requisite distance past the road sign, an embodiment may provide the user with the information associated with the road sign, as further elaborated upon in step 305. In a similar embodiment, the ruleset may specify that the point corresponds to a predetermined time after the user has traveled past a road sign. For example, the ruleset may specify that information associated with a road sign should be provided to the user 5 minutes after they had passed the sign. Responsive to identifying that the requisite time has elapsed since the user passed the road sign, an embodiment may provide the user with the information associated with the road sign, as further elaborated upon in step 305

In an embodiment, additional context data may be obtained and processed by the system to facilitate automatic modifications to the ruleset. For example, a ruleset may originally specify that information associated with a road sign should be provided 5 miles past the road sign, however, the road exit for services advertised in the road sign is only 2 miles away. In such a situation, an embodiment may identify, via analysis of the sign information, a discrepancy between the ruleset and the context of the sign. Accordingly, an embodiment may institute a modification to the ruleset by, for example, providing an indication of the information on the sign a predetermined distance before the road exit (e.g., ¼ mile before the road exit, etc.).

Responsive to not identifying, at 303, a point at which to provide the sign information, an embodiment may, at 304, take no additional action. Additionally or alternatively, an embodiment may resort to default settings that simply display the sign information substantially immediately once it is detected. Conversely, responsive to identifying, at 303, a point at which to provide the sign information, an embodiment may, at 305, provide the sign information to the user at the identified point.

In an embodiment, the road sign information may be provided to the user in one or more different ways. For example, the exact image captured of the road sign may be displayed on a display associated with the user's device (e.g., on a display screen of the user's phone, on a display screen of a vehicle's navigation system, etc.). In an embodiment, a single road side image may be displayed (e.g., of the most recent road sign, etc.) or a multitude of images may be displayed (e.g., of X number of road signs, etc.) simultaneously. Situations may arise in which a user is unable to direct their eyesight to a display to see the visual information. In view of these circumstances, an embodiment may additionally, or alternatively, provide an audible recitation of the sign information. The audible recitation may be output from one or more speakers associated with the user's device.

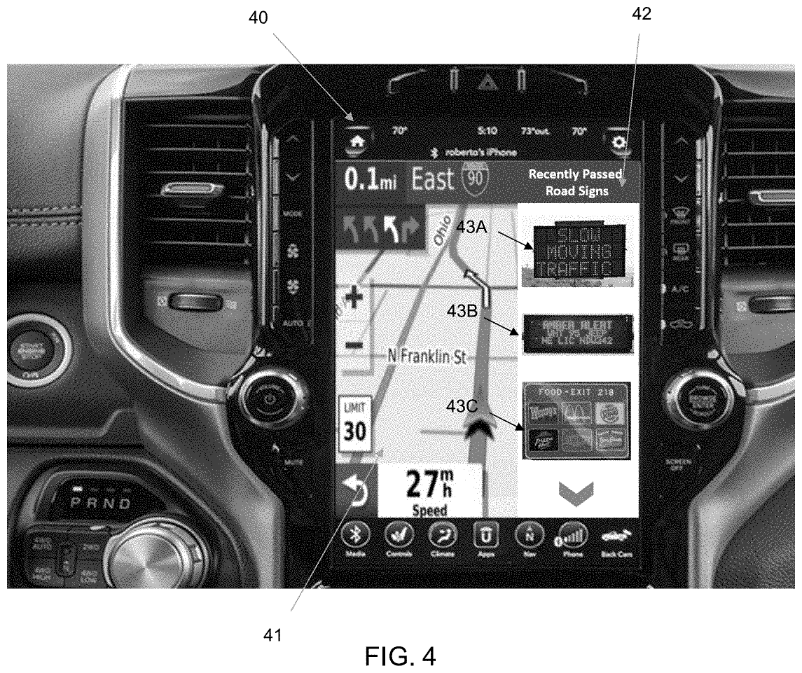

Turning now to FIG. 4, a non-limiting example illustration of visual road sign information provision is provided. As seen from the figure, a display 40 integrated within a vehicle may contain navigation data 41 alongside road sign information 42. The road sign information 42 may include the images of the road signs that were recently passed, i.e., 43A, 43B, and 43C. In an embodiment, in situations where multiple road signs are simultaneously displayed the order of the displayed road signs may be dictated by a policy in a user profile associated with the user. For example, the policy may dictate that certain categories of road signs are emphasized over others (e.g., a policy may specify that emergency alerts are displayed above signs billboard signs, etc.). As another example, the policy may dictate that more relevant road signs are displayed above all others (e.g., road signs with an upcoming road exit may be prioritized over road signs having an exit further away or road signs that don't necessarily have a road exit or mile marker relevance, etc.).

In addition to or in lieu of the user-designated settings for providing road sign information, an embodiment may provide road sign information to the user in more unique and contextually dynamic ways. For instance, an embodiment may be able to leverage additional available data sources to decide which sign information may be relevant to a user at certain points in time. For example, an embodiment having knowledge of a vehicles' fuel level data (e.g., as received from a sensor, etc.) may be able to identify that the fuel level of the vehicle has fallen below a predetermined threshold (e.g., less than a quarter tank left, etc.) and may then display and/or emphasize information associated with a recently passed sign advertising a gas station. As another example, an embodiment having access to a user's recent driving data (e.g., driving time, driving distance, etc.) may identify that a user has driven more than a predetermined number of miles and/or driven for longer than a predetermined period of time and may then display and/or emphasize information associated with a recently passed sign for a rest stop or for a hotel.

The various embodiments described herein thus represent a technical improvement to conventional methods for providing signage information to a user at point that may be useful for them. Using the techniques described herein, an embodiment may receive an indication of a road sign passed by a user. An embodiment may then store information associated with the road sign in a data repository and thereafter identify, from a ruleset, a point at which to automatically provide the information associated with the road sign to the user. Such a method may ensure that users receive notifications for road signs not just when they pass them, but at contextually relevant points.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device connected to a vehicle, an indication of a road sign in proximity to the vehicle;
storing, subsequent to the capturing, information associated with the road sign in a data repository;
identifying, by accessing a ruleset, a point at which to provide the information associated with the road sign to a user; and
providing, responsive to the identifying and by accessing the data repository, the information to the user at the identified point.

2. The method of claim 1, wherein the receiving the indication comprises detecting, using at least one camera associated with the information handling device, an image of the road sign.

3. The method of claim 2, wherein the providing comprises displaying the image of the road sign on a display screen of the information handling device.

4. The method of claim 1, wherein the receiving the indication comprises:
determining, using a global positioning system, a position of the vehicle; and
identifying, from sign location data contained within an accessible data base, that the road sign is associated with the position.

5. The method of claim 1, wherein the storing comprises:
identifying, within the ruleset, one or more categories of road signs designated by a user to be stored in the data repository;
determining, using a processor, whether the road sign is associated with one of the one or more categories;
storing, responsive to determining that the road sign is associated with one of the one or more categories, the information associated with the road sign in the data repository; and
disregarding, responsive to determining that the road sign is not associated with one of the one or more categories, the information associated with the road sign.

6. The method of claim 5, wherein the one or more categories are selected from the group consisting of: regulatory signs, warning signs, guide signs, emergency signs, traffic control signs, and advertisement signs.

7. The method of claim 1, wherein the identifying comprises identifying, within the ruleset, that the point corresponds to a predetermined distance that the vehicle has traveled past the road sign.

8. The method of claim 1, wherein the identifying comprises identifying, within the ruleset, that the point corresponds to a predetermined time since the vehicle passed the road sign.

9. The method of claim 1, wherein the identifying comprises identifying, within the ruleset, that the point corresponds to a predetermined distance before a road exit associated with the road sign.

10. The method of claim 1, wherein the road sign corresponds to a plurality of road signs stored in the data repository and wherein the providing comprises:
determining, using a processor, a user profile associated with the user of the vehicle;
identifying, within the user profile, a preferred display order of the plurality of road signs; and
displaying, on a display screen associated with the information handling device, the plurality of the road signs in the preferred display order.

11. An information handling device, comprising:
a processor;
wherein the information handling device is connected to a vehicle;
a memory device that stores instructions executable by the processor to:
receive an indication of a road sign in proximity to the vehicle;
store, subsequent to the capturing, information associated with the road sign in a data repository;
identify, by accessing a ruleset, a point at which to provide the information associated with the road sign to a user; and
provide, responsive to the identifying and by accessing the data repository, the information to the user at the identified point.

12. The information handling device of claim 11, wherein the instructions executable by the processor to receive the indication comprise instructions executable by the processor to detect, using at least one camera associated with the information handling device, an image of the road sign.

13. The information handling device of claim 12, wherein the instructions executable by the processor to provide comprise instructions executable by the processor to display the image of the road sign on a display screen of the information handling device.

14. The information handling device of claim 11, wherein the instructions executable by the processor to receive the indication comprise instructions executable by the processor to:
determine, using a global positioning system, a position of the vehicle; and
identify, from sign location data contained within an accessible data base, that the road sign is associated with the position.

15. The information handling device of claim 11, wherein the instructions executable by the processor to store comprise instructions executable by the processor to:
identify, within the ruleset, one or more categories of road signs designated by a user to be stored in the data repository;
determine whether the road sign is associated with one of the one or more categories;
store, responsive to determining that the road sign is associated with one of the one or more categories, the information associated with the road sign in the data repository; and
disregard, responsive to determining that the road sign is not associated with one of the one or more categories, the information associated with the road sign.

16. The information handling device of claim 11, wherein the instructions executable by the processor to identify comprise instructions executable by the processor to identify, within the ruleset, that the point corresponds to a predetermined distance that the vehicle has traveled past the road sign.

17. The information handling device of claim 11, wherein the instructions executable by the processor to identify comprise instructions executable by the processor to identify, within the ruleset, that the point corresponds to a predetermined time since the vehicle passed the road sign.

18. The information handling device of claim 11, wherein the instructions executable by the processor to identify comprise instructions executable by the processor to identify, within the ruleset, that the point corresponds to a predetermined distance before a road exit associated with the road sign.

19. The information handling device of claim 11, wherein the road sign corresponds to a plurality of road signs stored in the data repository and wherein the instructions executable by the processor to provide comprise instructions executable by the processor to:
determine a user profile associated with the user of the vehicle;
identify, within the user profile, a preferred display order of the plurality of road signs; and
display, on a display screen associated with the information handling device, the plurality of the road signs in the preferred display order.

20. A product, comprising:
a storage device that stores code, the code being executable by a processor and comprising:
code that receives, at an information handling device connected to a vehicle, an indication of a road sign in proximity to the vehicle;
code that stores, subsequent to the capturing, information associated with the road sign in a data repository;
code that identifies, by accessing a ruleset, a point at which to provide the information associated with the road sign to a user; and
code that provides, responsive to the code that identifies and by accessing the data repository, the information to the user at the identified point.
